(19) United States
(12) Patent Application Publication
(10) Pub. No.: US 2014/0082490 A1
(43) Pub. Date: Mar. 20, 2014

(54) USER TERMINAL APPARATUS FOR PROVIDING LOCAL FEEDBACK AND METHOD THEREOF

(71) Applicant: SAMSUNG ELECTRONICS CO., LTD., Suwon-si (KR)

(72) Inventors: Ji-hyun JUNG, Seongnam-si (KR); Jun-ho KOH, Suwon-si (KR); Chang-soo LEE, Seosan-si (KR)

(73) Assignee: SAMSUNG ELECTRONICS CO., LTD., Suwon-si (KR)

(21) Appl. No.: 14/029,169

(22) Filed: Sep. 17, 2013

(30) Foreign Application Priority Data
Sep. 18, 2012 (KR) 10-2012-0103475

(51) Int. Cl. G06F 3/01

(52) U.S. Cl. CPC G06F 3/016
USPC 715/702

(57) ABSTRACT

A user terminal apparatus including: a display configured to have flexibility and display a user interface (UI) screen; a feedback provider which locally provides a feedback effect in at least one area of the display; and a controller configured to control the feedback provider to locally provide the feedback effect to the at least one area of the display, among all areas of the display in response to determining that the user intends to provide an input on the UI screen.

### CROSS-REFERENCE TO RELATED APPLICATION

This application claims priority from Korean Patent Application No. 10-2012-0103475, filed on Sep. 18, 2012 in the Korean Intellectual Property Office, the disclosure of which is incorporated by reference in its entirety.

### BACKGROUND

1. Field

Apparatuses and methods consistent with exemplary embodiments relate to a user terminal apparatus and a method thereof. In particular, exemplary embodiments relate to a user terminal apparatus which provides a local feedback effect on a UI screen, and a method thereof.

2. Description of the Related Art

User terminal apparatuses of the related art, such as television (TVs), personal computers (PCs), laptops, tablet PCs, mobile phones, and MP3 players are widely used to an extent that they can be found in most households.

Most of the modern user terminal apparatuses in the related art are equipped with a displaying means. In recent years, the user terminal apparatuses are designed to be small in size with a large displaying means. Further, in the modern user terminal apparatuses of the related art, real buttons are omitted and an input screen is displayed on the displaying means for a user selection. Moreover, in the modern user terminal apparatuses of the related art, a soft keyboard, e.g., a virtual keyboard provides input to the input screen.

When a search area, a text window, a mail window, etc., is touched, the user terminal apparatus of the related art may display the input, such as a soft keyboard. Further, when a program such as Word is executed, the input, e.g., soft keyboard, may be automatically displayed.

A soft keyboard in the related art may be placed in various ways, according to a size or an aspect ratio of the displaying means provided on the related art user terminal apparatus. For example, number keys and character keys may be arranged similar to a real computer keyboard. Also, the input, e.g., soft keyboard, may be configured in such a manner that a plurality of characters may be assigned to each key, and a specific character may be selected according to a number of times that a corresponding key is selected.

However, since the input, such as a soft keyboard, is displayed on a flat displaying means, the user needs to keep their eyes on the input to accurately input text. Therefore, the user has difficulty in using the input similar to a real computer keyboard.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a user terminal apparatus which can provide a local feedback effect on a UI screen, and a method thereof.

According to an aspect of an exemplary embodiment, there is provided a user terminal apparatus including: a display configured to have flexibility and display a user interface (UI) screen; a feedback provider which locally provides a feedback effect in at least one area of the display; and a controller configured to control the feedback provider to locally provide the feedback effect to the at least one area of the display, among all areas of the display, in response to determining that a user intends to provide an input on the UI screen.

The controller may control the feedback provider to provide the feedback effect to the at least one area of the display which corresponds to a point at which a specific key is displayed on the UI screen.

The UI screen may include a soft keyboard including a plurality of keys. The controller may control the feedback provider to provide the feedback effect to the at least one area of the display which corresponds to a point at which at least one guide key which specifies a finger arrangement location, among the plurality of keys, is displayed.

The user terminal apparatus may further include an approach sensor configured to sense a user approach. The controller may determine that the user intends to provide the input on the UI screen in response to sensing the user approaching the UI screen when the UI screen is displayed.

The user terminal apparatus may further include a touch sensor configured to sense a user touch on the UI screen. The controller may control the feedback provider to provide a first feedback effect to the at least one area of the display that corresponds to a point at which a specific key is displayed on the UI screen in response to the user touching the UI screen with a pressure less than a predetermined level of pressure.

The UI screen may include a soft keyboard including a plurality of keys. The specific key may be at least one guide key which specifies a finger arrangement location, among the plurality of keys. The controller may control the feedback provider to provide a second feedback effect to the at least one area of the display that corresponds to the point in response to the user touching the UI screen with a pressure greater than the predetermined level of pressure.

The feedback provider may include a plurality of piezoelectric elements in the user terminal apparatus, and which provide a haptic feedback effect by locally deforming a surface of the display.

The feedback effect may be at least one of a vibration, a protrusion, and a depression.

According to an aspect of another exemplary embodiment, there is provided a method for providing feedback of a user terminal apparatus, the method including: displaying a user interface (UI) screen on a display which has flexibility; and locally providing a feedback effect to at least one area of the display, among all areas of the display, in response to determining that a user intends to provide an input on the UI screen.

The feedback effect may be provided to the at least one area of the display which corresponds to a point at which a specific key is displayed on the UI screen.

The UI screen may include a soft keyboard including a plurality of keys. The feedback effect may be provided to the at least one area of the display which corresponds to a point at which at least one guide key which specifies a finger arrangement location, among the plurality of keys, is displayed.

The locally providing the feedback effect may include determining that the user intends to proved the input on the UI screen in response to sensing the user approaching the UI screen when the UI screen is displayed.

The locally providing the feedback effect may include providing a first feedback effect to the at least one area of the display that corresponds to a point at which a specific key is displayed on the UI screen in response to the user touching the UI screen with a pressure less than a predetermined level of pressure.

The UI screen may include a soft keyboard including a plurality of keys. The specific key may be at least one guide key which specifies a finger arrangement location, among the plurality of keys. The locally providing the feedback effect may include providing a second feedback effect to the at least one area of the display that corresponds to the point in response to the user touching the UI screen with a pressure greater than the predetermined level of pressure.

The locally providing the feedback effect may include automatically determining that the user intends to input on the UI screen in response to the UI screen being a UI screen through which the user inputs and the UI screen being displayed.

The locally providing the feedback effect may include providing a haptic feedback effect which locally deforms a surface of the display, by selectively driving at least one piezoelectric element which is arranged in the at least one area, among a plurality of piezoelectric elements in the user terminal apparatus.

According to an aspect of another exemplary embodiment, there is provided a method for providing feedback of a user terminal, the method including: displaying a user interface (UI) screen on a display; sensing a user touch and determining a touch pressure intensity of the user touch; and providing one of a first feedback effect and a second feedback effect to a local region of a predetermined location based on the touch pressure intensity of the user touch.

According to various exemplary embodiments described above, the feedback effect is locally provided on the UI screen. Accordingly, the user can easily utilize the configuration of the UI screen.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a configuration of a user terminal apparatus according to an exemplary embodiment;

FIG. 2 is a flowchart to illustrate a method for providing feedback according to an exemplary embodiment;

FIG. 3 is a view to illustrate feedback effects which are provided in the forms of depression and protrusion;

FIG. 4 is a view to illustrate an example of a UI screen on which a feedback effect is provided in the form of vibration;

FIG. 5 is a view to illustrate another example of a UI screen on which a feedback effect is provided on a guide location;

FIG. 6 is a view to illustrate a configuration of a piezoelectric element which is used in a feedback provider, and an operation thereof;

FIG. 7 is a view to illustrate a configuration of a feedback provider;

FIG. 8 is a view to illustrate an example of a cross section configuration of FIG. 7;

FIGS. 9 and 10 are views to illustrate various configurations of piezoelectric elements, and a driving principle thereof;

FIG. 11 is a view to illustrate a plurality of piezoelectric elements, and an example of a driving circuit thereof;

FIG. 12 is a block diagram illustrating a configuration of a user terminal apparatus according to another exemplary embodiment;

FIG. 13 is a flowchart to illustrate a method for providing feedback in the user terminal apparatus of FIG. 12;

FIG. 14 is a view to illustrate an example of a UI screen on which a local feedback effect is provided by user's approach;

FIG. 15 is a block diagram illustrating a configuration of a user terminal apparatus according to still another exemplary embodiment;

FIG. 16 is a flowchart to illustrate a method for providing feedback in the user terminal apparatus of FIG. 15;

FIG. 17 is a view illustrating an example of a UI screen on which various feedback effects are provided according to a user's touch;

FIG. 18 is a block diagram illustrating a configuration of a user terminal apparatus according to various exemplary embodiments; and

FIG. 19 is a view illustrating a program configuration which is usable in the user terminal apparatus of FIG. 18.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

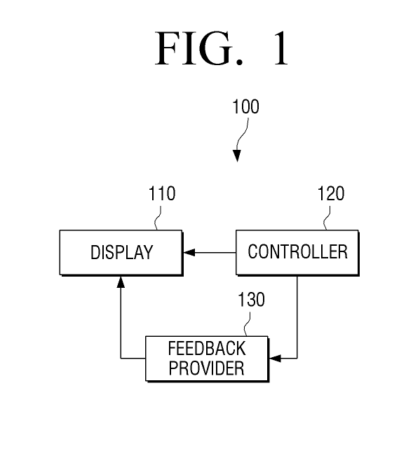

FIG. 1 is a block diagram illustrating a configuration of a user terminal apparatus according to an exemplary embodiment. The user terminal apparatus 100 may be implemented using various kinds of apparatuses such as a mobile phone, a personal digital assistant (PDA), an electronic album, an electronic book, an electronic scheduler, an MP3 player, a tablet PC, a laptop computer, a monitor, a kiosk, and a table PC.

Referring to FIG. 1, the user terminal apparatus 100 includes a display 110, a controller 120, and a feedback provider 130.

The display 110 is an element that displays a user interface (UI) screen. The UI screen recited herein refers to an application screen which is generated by executing various applications, an input screen on which a soft keyboard or various keys are displayed, a main screen on which various main menus are displayed, an icon display screen on which various icons are displayed, and a lock screen indicating a locking state.

The controller 120 generates the above-described UI screen by executing various applications or firmware, which is installed in the user terminal apparatus 100, and displays the UI screen on the display 110.

The feedback provider 130 is an element that provides a feedback effect to a local area, among all of the areas of the display 110. The feedback effect may be a haptic feedback effect which deforms a surface of the display 110. In particular, the feedback effect may be a vibration, protrusion, and depression. The local vibration is an effect that make some areas of the display 110 vibrate, and the local protrusion is an effect that makes some areas of the display 110 curve upward (swell up). The local depression refers to an effect that makes some areas of the display 110 curve downward. Also, shape deformation, which is a reaction to a force applied by the user, may be provided as a haptic feedback effect. In other words, when the user applies a force to the user terminal apparatus in a flat state, a feedback effect may be generated in which the surface rises up or is depressed in an opposite direction to a direction of the applied force. Hereinafter, the feedback effect is included in the protrusion or the depression.

In order to provide a piezoelectric feedback effect, the display 110 may have flexibility in a portion or in the whole display 110. When the whole display 110 has flexibility, the user terminal apparatus 100 may be called a flexible apparatus. A configuration of the display 110 will be explained in detail below.

When a specific condition is satisfied, the controller 120 may control the feedback provider 130 to locally provide a feedback effect to at least one area, among the whole area of the display 110. In particular, when a UI screen of a specific type is displayed, the controller 120 may control the feedback provider 120 to automatically provide a local feedback effect to a predetermined area on the UI screen. Also, when it is determined that the user intends to input on the UI screen while the UI screen is displayed, the controller 120 controls the feedback provider 130 to provide a local feedback effect to an area that is determined according to the user intended input. Accordingly, the user can easily recognize the configuration of the UI screen such as an arrangement of various objects on the UI screen through a sense of touch, without viewing the UI screen.

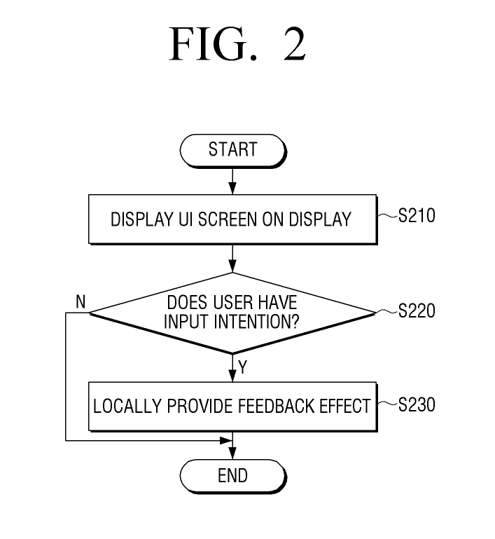

FIG. 2 is a flowchart to illustrate a method for providing feedback according to an exemplary embodiment. Referring to FIG. 2, the user terminal apparatus 100 displays a UI screen on the display (S210).

The user terminal apparatus 100 determines whether the user intends to input while the UI screen is displayed (S220). The method for determining whether the user intends to input may be implemented in various ways. In other words, it may automatically be determined that the user intends to input when a specific UI screen is displayed, and it may be determined that the user intends to input when the user approaches or touches the display.

When it is determined that the user intends to input, the user terminal apparatus 100 locally provides a feedback effect (S230).

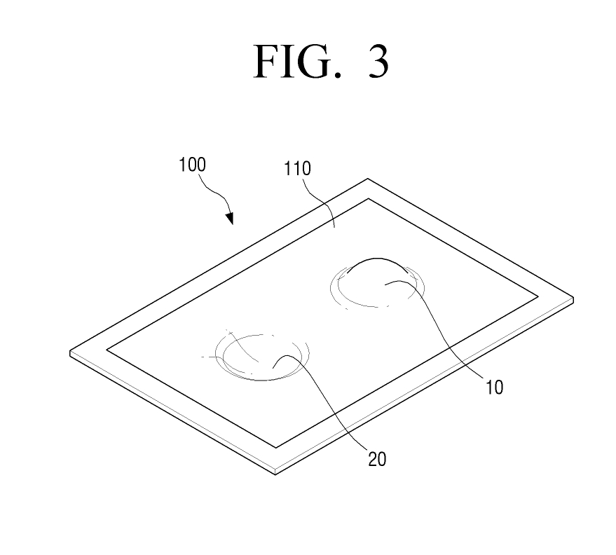

FIG. 3 is a view illustrating feedback effects which are provided in the forms of the depression and the protrusion. Referring to FIG. 3, a surface of one area 10 of the display 110 is deformed convexly, and a surface of another area 20 of the display 110 is deformed concavely. When a UI screen is displayed on the display 110, the controller 120 controls the feedback provider 130 to locally provide a feedback effect to a display area corresponding to a point at which a specific key of the UI screen is displayed.

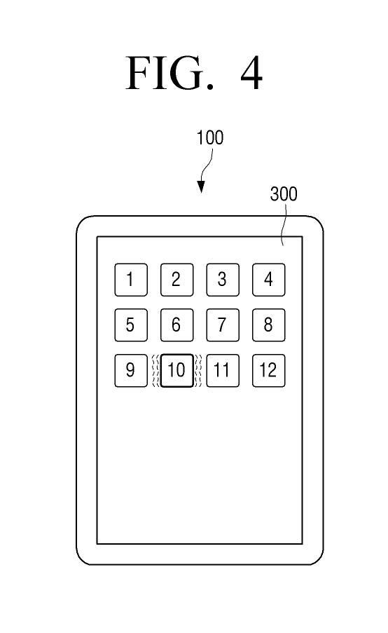

FIG. 4 is a view to illustrate a feedback effect which is provided in the form of a vibration. Referring to FIG. 4, an icon display screen 300, which includes a plurality of icons is displayed, and a vibration is generated on at least one icon. Although only the 10th icon is vibrated in FIG. 4, several icons may be vibrated simultaneously. Although the icon display screen 300 is illustrated as an example of the UI screen in FIG. 4, the feedback effect in the form of vibration may be provided to another type of UI screen. The controller 120 may selectively determine an icon to provide with a feedback effect, among the plurality of icons. For example, the controller 120 may control the feedback provider 130 to selectively vibrate a point where an icon is displayed and that either a finger of a user or a touch pen approaches or touches. The controller 120 may control the feedback provider 130 to selectively vibrate a point where an icon of a reference location of the UI screen is displayed. In addition, the controller 120 may control the feedback provider 130 to selectively vibrate a point where an icon satisfying a specific condition is displayed. The icon satisfying the specific condition may be an icon that is frequently selected by the user or most recently selected by the user, or an icon in which there is update news.

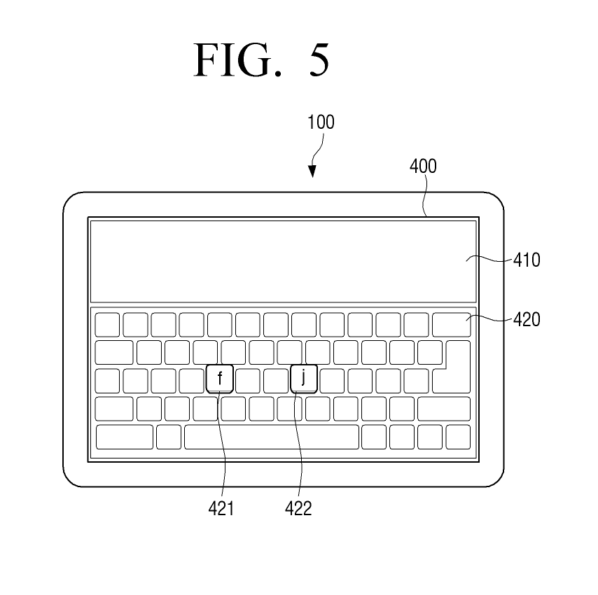

FIG. 5 is a view to illustrate a UI screen which includes an inputting means such as a soft keyboard and a method for providing feedback on the UI screen. Referring to FIG. 5, a UI screen 400 including an input window 410 and a soft keyboard 420 is displayed on the display 110 of the user terminal apparatus 100.

A plurality of keys is displayed on the soft keyboard 420. When the user selects various keys through the soft keyboard 420, characters or numbers corresponding to the selected keys may be displayed on the input window 410.

The keys displayed on the soft keyboard 420 may be arranged in the same pattern as that of a real keyboard. It is common that the real keyboard includes a plurality of character keys, a plurality of number keys, and a plurality of direction keys, a space bar, and en enter key. The user places their hands on the keyboard, and selects a key on the keyboard. At this time, a convex mark is formed on F and J keys, among the character keys, so that the user can place their fingers in a keyboard position without viewing the keyboard. In other words, the F and J keys may be guide keys for defining finger aligning positions. The controller 120 selects the F key 421 and the J key 422 of the soft keyboard 420 as guide keys. The controller 120 controls the feedback provider 130 to locally provide a feedback effect to a display area on which those guide keys are displayed.

Although the feedback effect in the above description only occurs on the guide keys such as the F and J keys, the feedback effect may be provided to a key that is frequently used such as the enter key or space bar. Further, keys other than the F or J key may be set as the guide key, according to the number of keys of the soft keyboard 420 and their arrangement patterns.

In order to locally provide a haptic feedback effect, the feedback provider 130 may include a plurality of piezoelectric elements.

Each of the piezoelectric elements may be implemented in various forms, such as a unimorph and bimorph.

The unimorph refers to a piezoelectric element where a single piezoelectric layer is stacked on a metal layer of a disk type. The metal layer and the piezoelectric layer of the piezoelectric element of the unimorph type may be implemented in a circle or other polygons. The piezoelectric layer may be comprised of a piezoelectric ceramic or piezoelectric polymer. The piezoelectric ceramic may be made of various materials such as PZT, PbTiO₃, and BaTiO₃. When a driving signal of a first polarity having a greater electric potential is applied to the lower piezoelectric layer of the unimorph piezoelectric element, the lower piezoelectric layer is expanded. Accordingly, the piezoelectric elements are deformed in such a manner that an edge area rises up and a center area goes down. On the other hand, when a driving signal of a second polarity having a lower electric potential is applied to the lower piezoelectric layer, the piezoelectric layer is contracted and is deformed in the opposite direction.

The bimorph refers to a piezoelectric element where two piezoelectric layers are stacked in sequence. The stacking type is manufactured by printing a metal electrode material on a ceramic sheet, compressing several sheets, adding an electrode, and sintering.

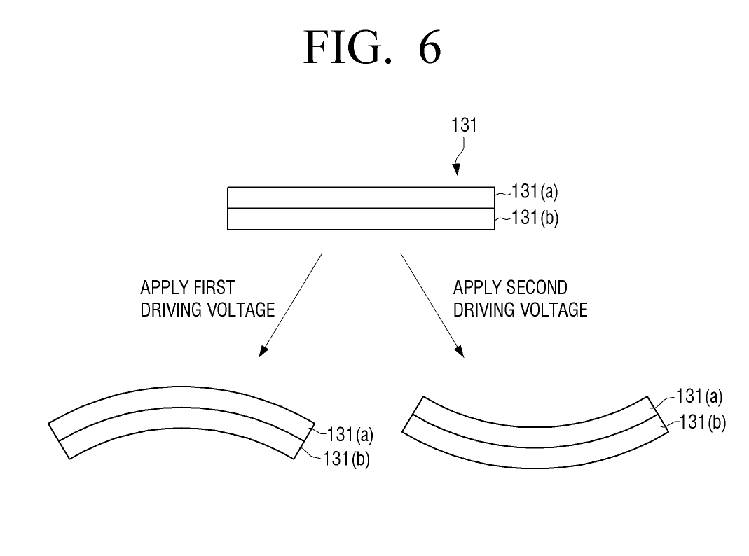

FIG. 6 is a view illustrating a configuration of a piezoelectric layer of a bimorph type. Referring to FIG. 6, a single piezoelectric element 131 includes an upper piezoelectric layer 131 (a) and a lower piezoelectric layer 131 (b). When the driving signal of the first polarity is applied to each of the upper piezoelectric layer 131(a) and the lower piezoelectric layer 131(b), the upper piezoelectric layer 131(a) and the lower piezoelectric layer 131(b) are expanded. On the other hand, when the driving signal of the second polarity, which is opposite to the first polarity, is applied to each of the upper piezoelectric layer 131(a) and the lower piezoelectric layer 131(b), the upper piezoelectric layer 131(a) and the lower piezoelectric layer 131(b) are contracted. The first polarity is a positive (+) polarity and the second polarity is a negative (−) polarity. The driving signal is a voltage waveform.

When a first driving voltage is applied, the first piezoelectric layer 131(a) is expanded and the second piezoelectric layer 131(b) is contracted. Accordingly, the piezoelectric element 131 is bent toward the second piezoelectric layer 131(b). On the other hand, when a second driving voltage is applied, the first piezoelectric layer 131(a) is contracted and the second piezoelectric layer 131(b) is expanded. Accordingly, the piezoelectric element 131 is bent toward the first piezoelectric layer 131(a).

Although the two piezoelectric layers are directly stacked in FIG. 6, an intermediate layer may be further included between the piezoelectric layers. This will be explained in detail below with reference to the drawings.

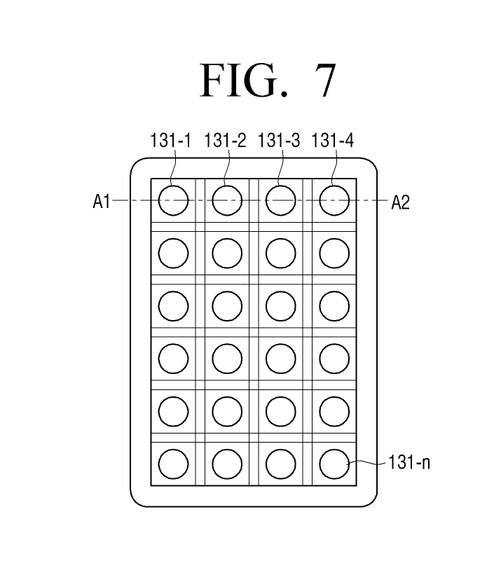

FIG. 7 is a view illustrating a plurality of piezoelectric elements 131-1 to 131-n which are distributed in the user terminal apparatus 100. In FIG. 7, four piezoelectric elements are arranged in a horizontal direction and seven piezoelectric elements are arranged in a vertical direction. In other words, the user terminal apparatus 100, including 28 total piezoelectric elements is illustrated. The piezoelectric elements 131-1 to 131-n are separated from one another by a regular distance, and are arranged in cells which are separated by partitions. Although each of the piezoelectric elements 131-1 to 131-n has a circular plane shape, the piezoelectric elements 131-1 to 131-n may be implemented in a bar shape, a quadrangular shape, or other polygonal shapes. The user terminal apparatus 100 may provide a feedback effect by selectively driving only the piezoelectric element that is disposed on an area to be locally deformed, among the piezoelectric elements 131-1 to 131-n in the cells.

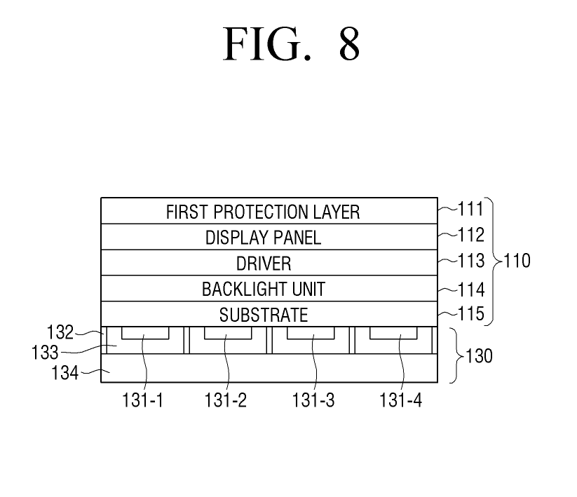

FIG. 8 is a view illustrating an example of a cross section configuration of the user terminal apparatus 100 of FIG. 7. Specifically, FIG. 8 illustrates a cross section taken along line A1-A2 of FIG. 7. Referring to FIG. 8, the display 110 of the user terminal apparatus 100 includes a first protection layer 111, a display panel 112, a driver 113, a backlight unit 114, and a substrate 115.

The first protection layer 111 protects the display panel 112. For example, the first protection layer 111 may be made of ZrO, CeO₂, or Th O₂. The first protection layer 111 may be manufactured as a transparent film and may cover the entire surface of the display panel 112.

The display panel 112 may be implemented using a liquid crystal display (LCD), an organic light emitting diode (OLED), an electrophoretic display (EPD), an electrochromic display (ECD), and a plasma display panel (PDP). When the display panel 112 is implemented using the LCD, the backlight unit 114 may be used as shown in FIG. 8. The backlight unit 114 includes a light source which is disposed in a direct type or an edge type such as a lamp or an LED, and provides backlight toward the display panel 112.

The driver 113 drives the display panel 112. The driver 113 applies a driving voltage to a plurality of pixels which constitute the display panel 112. The driver 113 may be implemented by using a-si TFT, a low temperature poly silicon (LTPS) TFT, or an organic TFT (OTFT), etc. The driver 113 may also be implemented in various forms according to the form of the display panel 112. For instance, the display panel 112 may consist of an organic light emitting substance which includes a plurality of pixel cells, and an electrode layer which covers opposite surfaces of the organic light emitting substance. In this case, the driver 113 may include a plurality of transistors corresponding to the plurality of pixel cells of the display panel 112. When an electric signal is applied, each transistor allows the pixel cell connected thereto to emit light. Accordingly, an image may be displayed on the display panel 112. Although not shown in FIG. 8, a color filter may also be included. Each element of the display 110 of FIG. 8 is manufactured of organic material including carbon or in a thin form such as foil, and has flexibility. Accordingly, when at least one of the lower piezoelectric elements 131-1 to 131-n is driven and has its shape changed, the surface of the display 110 may be deformed in association with the deformation of the piezoelectric element.

The substrate 115 supports the above-described elements. The substrate 115 may be a plastic substrate that is implemented using various materials such as polyimide (PI), polycarbonate (PC), polyethyleneterephthalate (PET), polyethersulfone (PES), polyethylenenaphthalate (PEN), and fiber reinforced plastic (FRP).

The feedback provider 130 may be disposed under the display 110. The plurality of piezoelectric elements 131-1 to 131-n may be provided in the feedback provider 130, and may be mounted in a plurality of cells 133 which are divided by isolation walls 132. The cell 133 may be filled with air or may be filled with other dielectric materials. A lower portion of the cell 133 is packaged by the second protection layer 134. An electric circuit pattern, which is connected to each of the piezoelectric elements 131-1 to 131-n, may be provided on the substrate 115 or the second protection layer 134. The second protection layer 134 may be manufactured of material similar to that of the first protection layer 111.

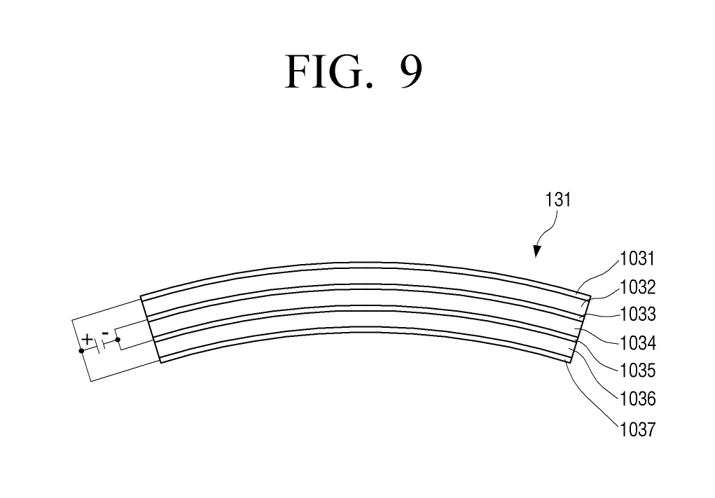

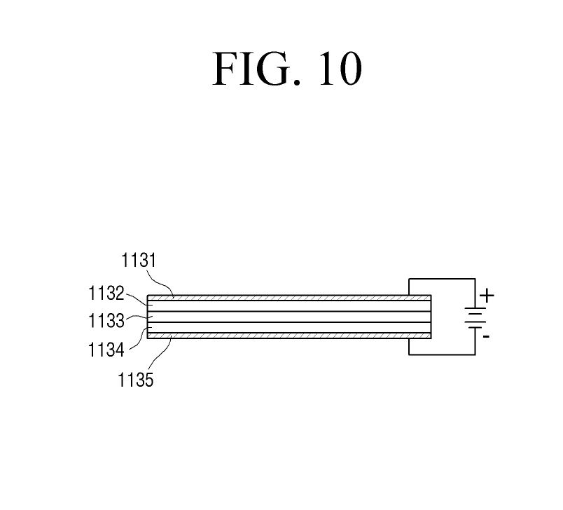

FIGS. 9 and 10 are views to illustrate various configuration examples of a piezoelectric element and a driving method thereof.

Referring to FIG. 9, a piezoelectric element 131 includes a first electrode 1031, a first piezoelectric layer 1032, a second electrode 1033, an intermediate layer 1034, a third electrode 1035, a second piezoelectric layer 1036, and a fourth electrode 1037. FIG. 9 is a view illustrating an example of a bimorph piezoelectric element including a plurality of piezoelectric layers. Referring to FIG. 9, electrodes are arranged on upper and lower surfaces of the first piezoelectric layer 1032 and upper and lower surface of the second piezoelectric layer 1036. The intermediate layer 1034 may be made of elastic material having flexibility. A length that can be extended to the maximum according to a voltage may be determined as a length of each of the piezoelectric layers and the intermediate layer based on measured experimental data.

When a positive (+) voltage is applied to the first electrode 1031 and the fourth electrode 1037 and a negative (−) voltage is applied to the second electrode 1033 and the third electrode 1035 as shown in FIG. 9, an electric field of a positive (+) polarity is generated in the first piezoelectric layer 1032. Accordingly, piezoelectric material in the first piezoelectric layer 1032 is polarized in the direction of the electric field, and a length of a crystal increases. In other words, the first piezoelectric layer 1032 extends in a lengthwise direction. On the other hand, an electric field of a negative (−) polarity is generated in the second piezoelectric layer 1036. Accordingly, the second piezoelectric layer 1036 contracts in the lengthwise direction. As a result, the piezoelectric element 131 is bent so that the first piezoelectric layer 1032 curves outwardly.

FIG. 10 illustrates electrodes which are provided on the upper and lower surfaces of the piezoelectric element 131. Referring to FIG. 10, the piezoelectric element 131 includes a first electrode 1131, a first piezoelectric layer 1132, an intermediate layer 1133, a second piezoelectric layer 1134, and a second electrode 1135.

When a positive (+) signal is applied to the first electrode 1131 and a negative (−) signal is applied to the second electrode 1134 as shown in FIG. 10, the first piezoelectric layer 1132 extends and the second piezoelectric layer 1134 contracts. Accordingly, the piezoelectric element 131 is bent downwardly.

On the other hand, in order to apply a driving signal to each piezoelectric layer individually, an electrode pattern may be provided. The electrode pattern is a pattern for connecting the electrode connected with each piezoelectric layer and an internal power source of the user terminal apparatus 100.

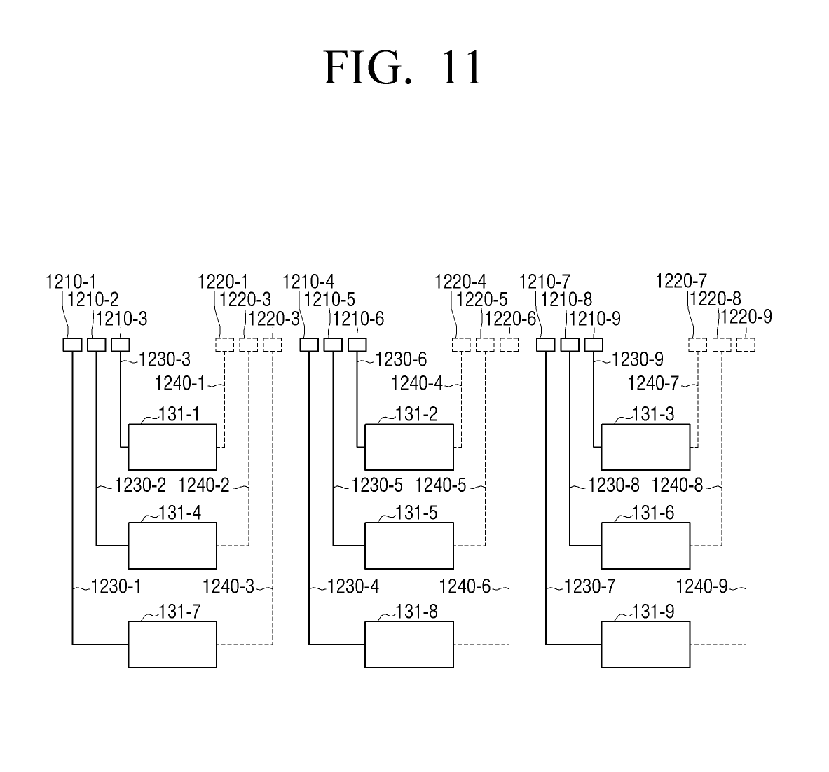

FIG. 11 illustrates an example of the electrode pattern. Referring to FIG. 11, the feedback provider 130 includes a plurality of piezoelectric elements 131-1 to 131-9 which are arranged in the form of a matrix. In FIG. 11, bar-shaped piezoelectric elements 131-1 to 131-9 are illustrated.

Upper circuit lines 1230-1 to 1230-9 are connected to the first piezoelectric layers of the piezoelectric elements 131-1 to 131-9, respectively. Upper electrode pads 1210-1 to 1210-9 are connected to the upper circuit lines 1230-1 to 1230-9, respectively.

Lower circuit lines 1240-1 to 1240-9 are connected to the second piezoelectric layers of the piezoelectric elements 131-1 to 131-9. Lower electrode pads 1220-1 to 1220-9 are connected to the lower circuit lines 1240-1 to 1240-9, respectively.

The controller 120 applies driving signals to the electrode pads, which are connected to the piezoelectric elements of the location that the user intends to deform, among the upper electrode pads and the lower electrode pads. Thus, a local feedback effect is provided. When the controller 120 applies a first driving signal to a single piezoelectric element, the piezoelectric element curves upwardly and the surface of the display 110 protrudes up. When the controller 120 applies a second driving signal to a piezoelectric element, the piezoelectric element curves downwardly and the surface of the display 110 is depressed. The controller 120 may cause a vibration effect by applying an alternating current (AC) voltage to opposite ends of the piezoelectric element, or by applying the first driving signal and the second driving signal alternately in a very short time.

When the bar-shaped piezoelectric elements 131-1 to 131-9 are provided as shown in FIG. 11, one end or opposite ends of the piezoelectric elements 131-1 to 131-9 may be fixed to the substrate 115 and displacement may be performed in a portion that is not fixed. For example, when one end of the piezoelectric elements 131-1 to 131-9 is fixed, the other end may be bent upwardly or downwardly. When the opposite ends of the bar-shaped piezoelectric element is fixed, the center of the piezoelectric element is bent to curve upwardly or downwardly.

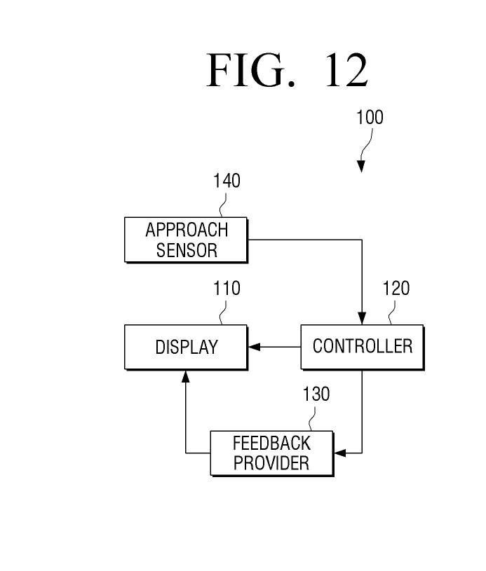

FIG. 12 is a block diagram illustrating a configuration of a user terminal apparatus according to another exemplary embodiment. Referring to FIG. 12, a user terminal apparatus 100 includes a display 110, a controller 120, a feedback provider 130, and an approach sensor 140. The basic configurations and operations of the display 110, the controller 120, and the feedback provider 130 have been described above with reference to FIG. 1. Hence, basic configurations and operations will not be repeated.

The approach sensor 140 is an element for sensing a user approach. The approach sensor 140 may include various kinds of sensors such as an infrared ray (IR) sensor, a photodiode, and a camera. When the approach sensor 140 includes the camera, the camera may continue to photograph a user. The controller 120 analyzes the photographed image and calculates an area of an object in the image such as a user hand. When the area of the object in the current image becomes larger than that of a previous image, the controller 120 determines that the user is approaching the display 110 of the user terminal apparatus 100. When the IR sensor or the photodiode is used, the controller 120 measures a time at which a reflecting signal reflected from the object such as the user hand after an IR signal or an optical signal is emitted is received, and calculates a change in the distance between the user terminal apparatus 100 and the user. Accordingly, it may be determined whether the user approaches or recedes from the user terminal apparatus 100.

When the user approach to the UI screen is sensed while the UI screen is displayed on the display 110, the controller 120 determines that the user intends to input on the UI screen. When it is determined that the user intends to input, the controller 120 controls the feedback provider 130 to locally provide a feedback effect on the UI screen.

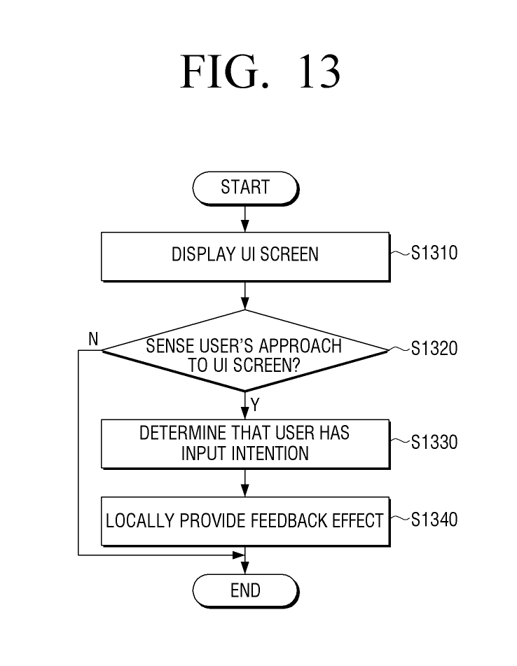

FIG. 13 is a flowchart to illustrate a method for providing feedback of the display apparatus of FIG. 12. Referring to FIG. 13, when a UI screen is displayed (S1310) and user approach to the UI screen is sensed (S1320), the user terminal apparatus determines that the user intends to input (S1330). The method for sensing the approach may be performed using various sensors as described above, or may be performed in other sensing methods. When it is determined that the user intends to input, the user terminal apparatus provides a local feedback effect (S1340). The feedback effect may be various kinds of piezoelectric feedback effects as described above, and may further include a visual feed effect according to an exemplary embodiment. The visual feedback effect refers to various image processing operations, such as increasing brightness of a specific area in the UI screen or magnifying or deforming an image displayed on the specific area. The configuration for providing the piezoelectric feedback effect has been described above, and a redundant explanation is omitted.

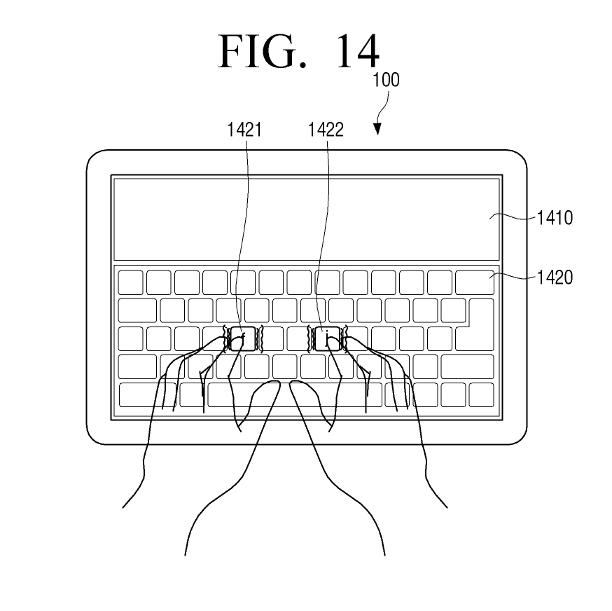

FIG. 14 is a view to illustrate an example of a UI screen, which is displayed through the display of FIG. 13 and a method for providing feedback thereof. Referring to FIG. 14, the user terminal apparatus 100 displays a UI screen 1400 which includes an input window 1410 and a soft keyboard 1420. The soft keyboard 1420 has keys arranged in the similar form to that of a real keyboard.

When a function requiring a user input such as mailing, messenger, messaging, and creating a document is executed, the controller 120 displays the UI screen 1400 including the soft keyboard 1420 as shown in FIG. 14. The controller 120 may normally maintain the surface of the display 110 on which the soft keyboard 1420 is displayed in a flat state. When the user places both of their hands on the soft keyboard 1420 as shown in FIG. 14, the approach sensor 140 senses approach of the users hands and notifies the controller 120. When an approach sensing signal is received, the controller 120 controls the feedback provider 130 to locally provide a feedback effect to F and J keys 1421 and 1422 which correspond to guide keys in the software keyboard 1420. Although FIG. 14 illustrates a local vibration effect, depression or protrusion may be formed.

In FIG. 14, the local feedback effect occurs only on the keys of the location determined when the user approach is sensed, e.g., the guide keys. However, the location where the feedback effect occurs may vary according to a user approaching direction. In other words, the controller 120 analyzes a user moving direction, and determines which direction the user faces to in the UI screen. For example, when the approach sensor 140 includes a camera, the controller 120 compares photographed images and determines the user moving direction. Also, the controller 130 determines which direction the user faces to in the UI screen, with reference to a shooting angle of the camera. The controller 120 may control the feedback provider 130 to provide the local feedback effect to the location that the user faces.

FIG. 14 illustrates an example of a screen configuration of a tablet PC. However, the user terminal apparatus may be implemented using various kinds of electronic apparatuses besides the tablet PC. An aspect ratio, a size, and a shape of the display panel may vary according to a type of the electronic apparatus. Accordingly, an aspect ratio, a size, and a shape of the soft keyboard screen may be designed according to the characteristics of the electronic apparatus. The screen configuration illustrated in drawings other than FIG. 14 may be implemented in various forms according to an exemplary embodiment.

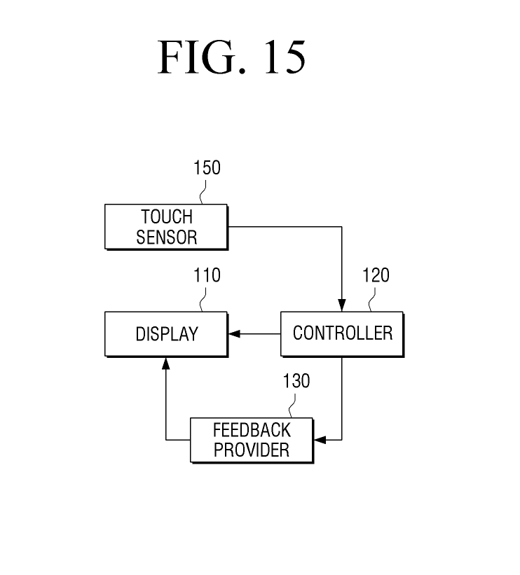

FIG. 15 is a block diagram illustrating a configuration of a user terminal apparatus according to still another exemplary embodiment. Referring to FIG. 15, a user terminal apparatus 100 includes a display 110, a controller 120, a feedback provider 130, and a touch sensor 150. The basic configurations and operations of the display 110, the controller 120, and the feedback provider 130 have been described above with reference to FIG. 1. Therefore, the basic configurations and operations will not be repeated.

The touch sensor 150 is an element that senses a user touch on the surface of the display 110. The touch sensor 150 may be implemented using a capacitive type or a resistive type of sensor. The capacitive type calculates touch coordinates by sensing minute electricity excited in a user body when a part of the user body touches the surface of the display 110, using a dielectric substance coated on the surface of the display 110. The resistive type includes two electrode plates. When a user touches a screen, touch coordinates are calculated by sensing an electric current flowing, due to contact between upper and lower plates at the touched point. As described above, the touch sensor 150 may be implemented in various forms.

When the touch coordinates are sensed, the controller 120 compares the touch coordinates and screen display coordinates. Accordingly, the controller 120 identifies a screen object displayed at the touch point, and performs an operation corresponding to the screen object.

The controller 120 may perform different operations according to an intensity of touch. For example, when the user touches the UI screen with pressure less than a predetermined level of pressure, it is determined that the user intends to input on the UI screen. Accordingly, the controller 120 may control the feedback provider 130 to provide a first feedback effect to an area of the display 110 corresponding to a point where a specific key is displayed in the UI screen. The specific key may be a guide key, a reference key, or a favorite key other than a key displayed at a touch point.

For example, when the UI screen including the soft keyboard is displayed as described above, the user may place their hands on the soft keyboard. Accordingly, certain keys in the soft keyboard may be slightly touched. When each key is touched but an intensity of touch is less than a predetermined level of pressure, the controller 120 does not input characters or numbers corresponding to the keys, and instead controls the feedback provider 130 to locally provide the first feedback effect to the guide keys such as F and J keys. The first feedback effect may be a vibration that the user can easily sense when placing their fingers.

When the user touches the UI screen with pressure greater than the predetermined level of pressure, the controller 120 may control the feedback provider 130 to provide a second feedback effect to an area of the display 110 corresponding to the touch point. In other words, pressure that is measured when the user presses a key with the intention of inputting is generally greater than pressure that is sensed when the user unintentionally touches to arrange their fingers. Using experimental trials, a boundary value between the pressure when the user touches with the intention of inputting and the pressure when the user touches without the intention of inputting may be determined. The boundary value may be stored in the user terminal apparatus, and may be utilized as a reference pressure level.

The controller 120 senses pressure when the user places their fingers on the screen, and may set the pressure at that time as a reference pressure. After that, when pressure greater than the reference pressure is sensed, it is determined that the touch is input.

The shapes and intensities of the first feedback effect and the second feedback effect may individually be set. For example, when the first feedback effect is provided in the form of protrusion or depression, the second feedback effect may be provided in the form of vibration. On the other hand, the first feedback effect and the second feedback effect may be provided in the form of vibration, and the vibration of the second feedback effect may be greater than that of the first feedback effect. Also, the first feedback effect and the second feedback effect may have different vibration patterns. For example, a single vibration may occur on the F and J keys which are guide keys, and multiple vibrations may occur on a key that the user touches with pressure greater than the predetermined level of pressure so that the user can feel the vibration for a long time.

The controller 120 may control the feedback provider 130 to provide the first feedback effect and the second feedback effect according to a setting value. When it is determined that the UI screen is continuously used, the controller 120 may control the feedback provider 130 to remove the first feedback effect and provide only the second feedback effect, or to remove all of the first and second feedback effects in order to prevent user confusion. It is determined whether the UI screen is continuously used or not based on whether a time interval at which the user touches falls within a predetermined time or not.

In FIG. 15, it is determined which of the first feedback effect and the second feedback effect is provided based on the predetermined level of reference pressure. However, according to another exemplary embodiment, it may be determined which of the first feedback effect and the second feedback effect is provided based on a number of touch points. For example, when the soft keyboard is displayed as explained above, a basic position is set to place four left fingers and four right fingers on corresponding keys. In this case, a touch is performed at a total of 8 points. Therefore, when the number of touch points is greater than 8, the controller 120 determines that the user fingers are aligned and automatically provides the first feedback effect. The controller 120 may provide the first feedback effect every time that the user takes all fingers off the surface of the display 110 and then touches the surface using the soft keyboard.

In the above-described soft keyboard, the guide keys are F and J keys. However, the guide keys may be changed or deleted, or added by the user at their convenience.

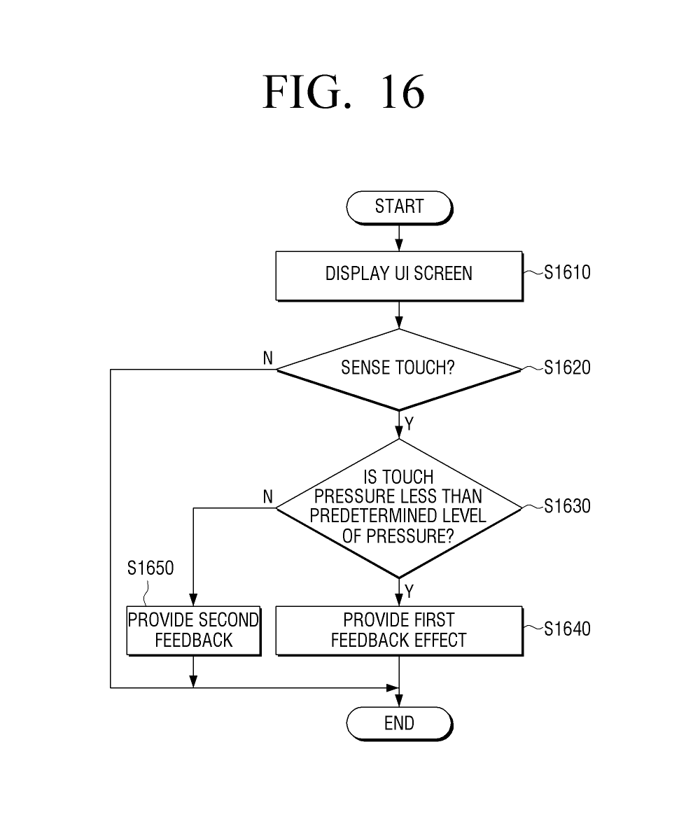

FIG. 16 is a flowchart to illustrate a method for providing feedback according to the exemplary embodiment of FIG. 15. Referring to FIG. 16, when a UI screen is displayed (S1610) and a touch is sensed (S1620), an intensity of touch is determined. When it is determined that touch pressure less than a predetermined level of pressure is sensed, the first feedback effect is locally provided to a predetermined location (S1640). On the other hand, when it is determined that touch pressure greater than the predetermined level of pressure is sensed, the user terminal apparatus locally provides the second feedback effect to the touch point (S1650). When the second feedback effect occurs, the user determines that their touch is normally recognized. Accordingly, the user can easily grasp the configuration of the UI screen using only the sense of touch, and can also easily grasp an exact touch manipulation.

In the above-described exemplary embodiments, the approach sensor and the touch sensor are separately used, but these sensors may be used altogether.

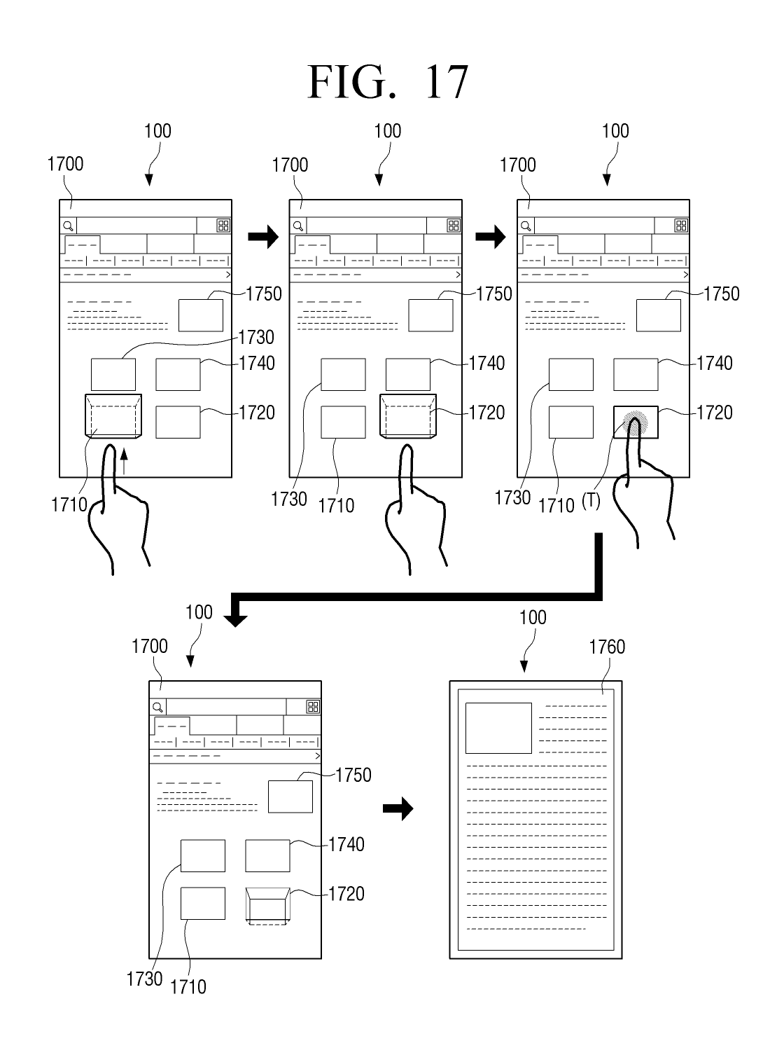

FIG. 17 is a view to illustrate an operation of a user terminal apparatus which includes both an approach sensor and a touch sensor. Referring to FIG. 17, a web page screen 1700 is illustrated as an example of the UI screen. Objects 1710 to 1750, such as various images or texts, are displayed on the web page screen 1700. The objects 1710 to 1750 are created in a markup language and distinctly recognized. The controller 120 of the user terminal apparatus determines whether the user approaches the web page screen 1700 or not using the approach sensor 140. When it is determined that the user approaches the web page screen 1700, the user terminal apparatus locally provides a feedback effect to the object displayed on a location that the user approaches. FIG. 17 illustrates the user approaching the first object 1710. Accordingly, a feedback effect is provided in such a manner that the first object 1710 swells up. In this state, when the user moves his/her finger to the right, the feedback effect is provided to the second object 1720 such that the second object 1720 swells up.

In this state, when the user touches the second object 1720 (T), depression is formed to make the second object 1720 curve downwardly. After that, the web page screen 1700 is changed to a screen 1760 corresponding to the second object 1720 and the depression state returns to the original state. In FIG. 17, the web page screen is illustrated. However, the feedback effect may be selectively provided to the other types of UI screens, according to the user approach or touch.

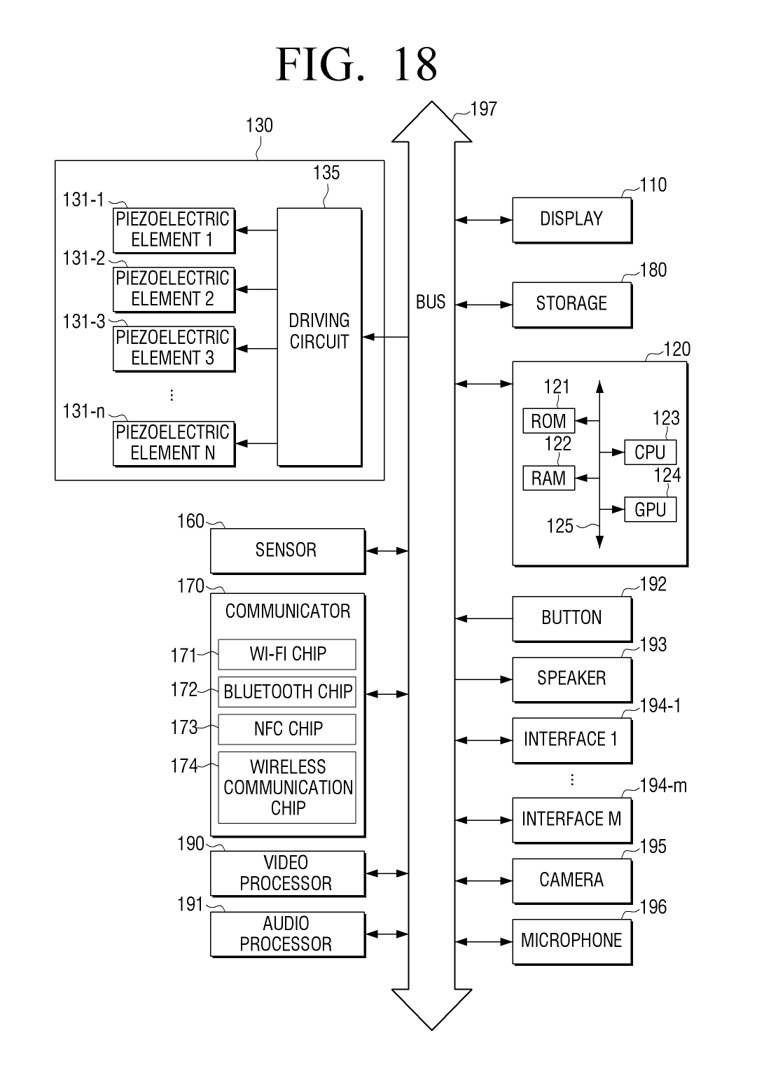

FIG. 18 is a block diagram to illustrate elements that are included in a user terminal apparatus according to various exemplary embodiments. Referring to FIG. 18, the user terminal apparatus 100 includes a feedback provider 130 which includes a plurality of piezoelectric elements 131-1 to 131-n and a driver 135, a display 110, a controller 120, a sensor 160, a communicator 170, a video processor 191, an audio processor 192, a storage 180, a button 192, a speaker 193, interfaces 194-1 to 194-m, a camera 195, and a microphone 196.

The feedback provider 130 includes the plurality of piezoelectric elements 131-1 to 131-n, and the driver 135.

The configuration of the plurality of piezoelectric elements 131-1 to 131-n and the driving method thereof have been described above, Thus, a redundant explanation is omitted.

The driver 135 is an element that applies a driving signal to the piezoelectric elements 131-1 to 131-n. The driver 135 may generate driving signals of various sizes and polarities using power provided by a battery (not shown). The driving signal may be generated in the form of a pulse signal.

The display 110 may be made of flexible material in whole or in part, and performs various display operations under the control of the controller 120.

The sensor 160 may include at least one sensor. In particular, the sensor 160 may further include various kinds of sensors such a geomagnetic sensor, a gyro sensor, an acceleration sensor, a pressure sensor, and a bend sensor besides the approach sensor and the touch sensor.

The geomagnetic sensor senses a rotation state and a moving direction of the user terminal apparatus 100. The gyro sensor senses a rotation angle of the user terminal apparatus 100. The acceleration sensor senses a degree of tilt of the user terminal apparatus 100. The pressure sensor senses a magnitude of pressure exerted to the user terminal apparatus 100 when the user performs touch or bending manipulation, and provides the magnitude of pressure to the controller 120. The pressure sensor may include a piezo film which is embedded in the display 110 and outputs an electric signal corresponding to the magnitude of pressure. The bend sensor is a sensor for sensing bending of the user terminal apparatus. The bend sensor may be implemented by using a plurality of strain gages. The strain gage uses metal or a semiconductor, in which a resistance is greatly changed according to an applied force, and senses deformation of a surface of an object to be measured according to a change in the resistance value. It is common that a material, such as metal, increases a resistance value when its length is stretched by an external force, and decreases the resistance value when the length is contracted. Accordingly, it is determined whether bending is performed or not by sensing a change in the resistance value. The bend sensor may be included when the user terminal apparatus 100 has flexibility, i.e., is implemented using a flexible apparatus.

The controller 120 may control the operation of the user terminal apparatus according to a state value that is sensed by the sensor 160. In particular, the controller 120 may control the feedback provider 130 to locally provide the feedback effect described above, based on a sensing value which is sensed by the approach sensor, the touch sensor, and the pressure sensor.

The communicator 170 may communicate with various types of external apparatuses according to various communication methods. The communicator 170 may include various communication chips such as a Wi-Fi chip 171, a Bluetooth chip 172, a near field communication (NFC) chip 173, and a wireless communication chip 174.

The Wi-Fi chip 171, the Bluetooth chip 172, and the NFC chip 173 communicate with external apparatuses in a Wi-Fi method, a Bluetooth method, and an NFC method, respectively. Among these, the NFC chip 173 is operated in the NFC method, which uses 13.56 MHz from among various RF-ID frequency bands such as 135 kHz, 13.56 MHz, 433 MHz, 860˜960 MHz, and 2.45 GHz. When the Wi-Fi chip 171 or the Bluetooth chip 172 is used, a variety of connection information, such as an SSID and a session key is exchanged, and connection is established using the connection information. Then, a variety of information is exchanged. The wireless communication chip 174 communicates with external apparatuses according to various communication standards such as IEEE, Zigbee, 3^{rd} generation (3G), 3^{rd} generation partnership project (3GPP), and long term evolution (LTE).

When the communicator 170 is provided, the controller 120 may exchange various messages with an external terminal apparatus or an access point by communicating with them. The message may include data that can cause a feedback effect. For example, when the message includes various objects such as images, texts, and photos, coordinates information or feedback characteristic information for making only a specific object in the message protrude, depressed, and vibrate may be included in the message.

For convenience, such data that causes the feedback effect is called haptic making data, and a message including such data is a haptic making message. When the haptic making message is received from the external terminal apparatus, the controller 120 may control the feedback provider 130 to locally provide the feedback effect to the object designated by the haptic making data in the message.

The controller 120 may add the haptic making data to the message to be transmitted. In particular, the controller 120 may display a menu for setting the feedback effect in a message creating UI. Accordingly, when the feedback effect is set using the menu, haptic making data is generated based on a setting value and a message including the generated data is transmitted to the external apparatus.

The video processor 190 is an element that processes video data. The video processor 190 may perform various image processing operations such as decoding, scaling, noise filtering, frame rate conversion, and resolution conversion with respect to the video data. The video data processed by the video processor 190 is displayed through the display 110.

The audio processor 191 refers to an element that processes audio data. The audio processor 184 performs various processing operations such as decoding, amplifying, and noise filtering with respect to audio data.

The audio processor 191 and the video processor may be used to process and play back a multimedia content or a DMB signal.

The speaker 193 outputs various notification sounds or voice messages as well as various audio data processed by the audio processor 191.

The button 192 may be implemented using various kinds of buttons such as a mechanical button, a touch button, and a wheel, which are formed on a certain area of the user terminal apparatus 100, such as a front surface, a side surface, and a bottom surface of a body exterior of the user terminal apparatus 100.

The camera 195 captures a still image or a moving picture according to control of the user. The camera 195 may be a plurality of cameras including a front camera and a rear camera.

The microphone 196 receives a user voice or other sounds, and converts them into audio data. The controller 120 may use the user voice input through the microphone 196 for a call process, or may convert it into audio data and store the audio data in the storage 180.

When the camera 195 and the microphone 196 are provided, the controller 120 may perform control operations according to a user voice input through the microphone 196 and a user motion recognized by the camera 195. In other words, the user terminal apparatus 100 may be operated in a motion control mode or a voice control mode, besides a touch or button selection mode. In the motion control mode, the controller 120 activates the camera 195 and captures a user, traces a change in the user motion, and performs a corresponding control operation. In the voice control mode, the controller 120 may perform voice recognition by analyzing a user voice input through the microphone 196 and performing control operation according to the analyzed user voice. When the user terminal apparatus 100 is implemented using a flexible apparatus and includes a bend sensor as described above, the operation of the user terminal apparatus 100 may be controlled according to a bending manipulation. In other words, when a predetermined bending manipulation is performed, the controller 120 may perform an operation corresponding to the bending manipulation.

In addition, the user terminal apparatus 100 may further include various interfaces 194-1 to 194-m to be connected to various external terminals such as a headset, a mouse, and a local area network (LAN). Although not shown, the user terminal apparatus 100 may further include a power supply (not shown). The power supply is an element that supplies power to each element. The driver 135 converts voltage provided from the power supply, generates a driving signal for each piezoelectric element, and provides the driving signal.

The storage 180 is an element which stores various programs and data used in the operation of the user terminal apparatus 100. The controller 120 may generate various UI screens by executing various programs stored in the storage 180.

The controller 120 controls an overall operation of the flexible apparatus 1000 using various programs stored in the storage 180.

The controller 120 includes a read only memory (ROM) 121, a random access memory (RAM) 122, a CPU 123, a graphic processing unit (GPU) 124, and a system bus 125.

The ROM 121, the RAM 122, the CPU 123, and the GPU 124 may be connected to one another through the system bus 125.

The CPU 123 accesses the storage 180 and performs booting using the O/S stored in the storage 180. The CPU 123 performs various operations using the various programs, content, and data stored in the storage 180.

The ROM 121 stores a set of commands to boot the system. When a turn on command is input and power is supplied, the CPU 123 copies the O/S stored in the storage 180 to the RAM 122 according to a command stored in the ROM 121, executes the O/S and boots the system. When the booting is completed, the CPU 123 waits for a user command. The user may input various user commands according to various input methods such as manipulating the button 192, user touch manipulation, motion input, and voice input.

The CPU 123 copies a program corresponding to the user command into the RAM 122, and performs various operations by executing an application program copied into the RAM 122. When it is necessary to create a UI screen, the CPU 123 provides a control signal for generating a UI screen to the CPU 124.

The GPU 124 generates a UI screen including various objects such as an icon, an image, and a text using a calculator (not shown) and a renderer (not shown). As described above, the UI screen may include various screens such as a desktop screen, an icon display screen, a soft keyboard screen, and a web page screen. The calculator calculates attribute values of each object to be displayed according to a layout of the screen, such as coordinates values, a shape, a size, and a color. The renderer generates a screen of various layouts including objects based on the attribute values calculated by the calculator. The screen generated by the renderer is displayed on a display area of the display 110.

The CPU 123 controls the feedback provider 130 to provide a local feedback effect according to a kind of a UI screen as described above. According to an exemplary embodiment, the CPU 123 may provide the feedback effect considering a result of sensing by the sensor 160.

The function of providing the feedback effect may be set by the user through a user setting menu. The CPU 123 stores the user setting value in the storage 180. The CPU 123 sets the user setting value in an internal register during a booting process, and uses the user setting value. The user setting value includes setting values on various items indicating whether to provide a local feedback effect, a kind of the feedback effect, and a location to receive the feedback effect. The kind of the feedback effect may indicate vibration, protrusion, and depression.

The user setting value may be set differently according to a user and stored, as described above. For example, in the case of a vibration effect, a vibration frequency or a vibration pattern may be set differently according to a user.

When the user logs in, the CPU 123 loads the user setting value corresponding to the user from the storage 180 and uses it. For example, when a user A logs in, the vibration effect is provided only to F and J keys in the soft keyboard screen at a first vibration frequency. When a user B logs in, the vibration effect is provided to a space key, an enter key, and F and J keys at a second vibration frequency. In other words, a location of a guide key, a kind of the feedback effect, and an intensity of feedback may be changed according to a user even in the same application.

In FIG. 18, the user terminal apparatus 100 is illustrated as an apparatus which is equipped with various functions, such as a function of communicating, a function of receiving a broadcast, and a function of reproducing a video, e.g., and various elements of the user terminal apparatus 100 are schematically illustrated. Accordingly, according to an exemplary embodiment, some of the elements illustrated in FIG. 18 may be omitted or modified, or another element may be added.

As described above, the controller 120 may perform various operations by executing a program stored in the storage 180.

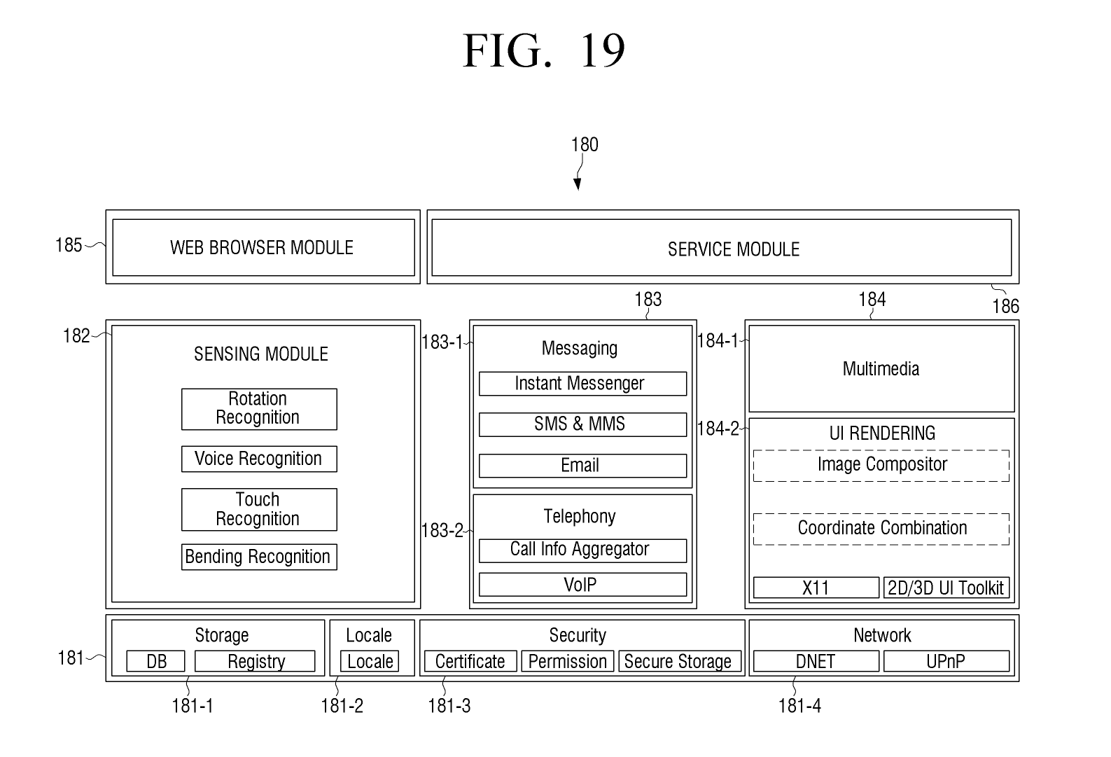

FIG. 19 is a view to explain software stored in the storage 180. Referring to FIG. 19, the storage 180 may store a base module 181, a sensing module 182, a communication module 183, a presentation module 184, a web browser module 185, and a service module 186.

The base module 181 refers to a module which processes signals transmitted from each hardware included in the user terminal apparatus 100, and transmits the signals to an upper layer module.

The base module 181 includes a storage module 181-1, a location-based module 181-2, a security module 181-3, and a network module 181-4.

The storage module 181-1 is a program module which manages a database (DB) or a registry. The CPU 123 may access the database in the storage 180 using the storage module 181-1, and may read out various data. The location-based module 181-2 is a program module which is interlocked and/or interacts with various hardware, such as a GPS chip, and supports a location-based service. The security module 181-3 is a program module which supports certification for hardware, permission of a request, and a secure storage. The network module 181-4 is a module to support network connection, and includes a Distributed.net (DNET) module and a Universal Plug and Play (UPnP) module.

The sensing module 182 is a module which collects information from various sensors included in the sensor 160, and analyzes and manages the collected information. In particular, the sensing module 182 is a program module which detects manipulation attributes such as coordinates values of a point where touch is performed, a touch moving direction, a moving speed, and a moving distance. In addition, according to circumstances, the sensing module 182 may include a rotation recognition module, a voice recognition module, a touch recognition module, an approach recognition module, a motion recognition module, and a bending recognition module. When a user approach or touch is sensed by the touch recognition module or approach recognition module, the controller 120 may determine whether to provide a local feedback effect on the UI screen based on a result of sensing.

The communication module 183 is a module to communicate with an external apparatus. The communication module 183 includes a messaging module 183-1 such as a messenger program (e.g., an instant messenger program, etc.), a short message service (SMS) and multimedia message service (MMS) program, and an email program, and a telephony module 183-2 which includes a call information aggregator program module and a voice over internet protocol (VoIP) module. The communication module 183 parses a message which is received from an external apparatus, and detects haptic making data. The CPU 123 analyzes the haptic making data which is detected by the communication module 183. The CPU 123 controls the feedback provider 130 to provide a local feedback effect according to the haptic making data. When a menu to give a feedback effect is selected while a message to be transmitted to an external apparatus is created, the communication module 183 generates haptic making data so that the external apparatus provides the feedback effect, and adds the haptic making data to the corresponding message. Accordingly, the haptic making message may be transmitted to the external apparatus.

The presentation module 184 is a module which generates a display screen. The presentation module 184 includes a multimedia module 184-1 to reproduce multimedia content and output the multimedia content, and a user interface (UI) rendering module 184-2 to process a UI and graphics. The multimedia module 184-1 may include a player module, a camcorder module, and a sound processing module. Accordingly, the multimedia module 144-1 generates a screen and a sound by reproducing various multimedia content, and reproduces the same. The UI rendering module 184-2 may include an image compositor module to combine images, a coordinate combination module to combine coordinates on a screen to display an image and generate coordinates, an X11 module to receive various events from hardware, and a 2D/3D UI toolkit to provide a tool for configuring a UI of a 2D or 3D format. The CPU 123 renders various UI screens by executing the presentation module 184. The CPU 123 provides location coordinates of a guide key on the UI screen to the feedback provider 130. The driver 135 of the feedback provider 130 applies a driving signal to a piezoelectric element corresponding to the location coordinates, and provides a local feedback effect.

The web browser module 185 is a module which performs web-browsing and accesses a web server. The web browser module 185 may include a web view module to render and view a web page, a download agent module to download, a bookmark module, and a web-kit module. The CPU 123 may generate a web page screen by executing the web browser module 185. The CPU 123 provides location coordinates of an object satisfying a predetermined condition in the web page screen to the feedback provider 130. The driver 135 of the feedback provider 130 applies a driving signal to a piezoelectric element corresponding to the location coordinates, and provides a local feedback effect.

The service module 186 is a module which includes various applications to provide services matched with manipulation when various user manipulations are performed. For example, the service module 186 may include a word program, an e-book program, a calendar program, a game program, a schedule management program, a notification management program, a content reproducing program, a navigation program, and a widget program. When a program that accompanies a local feedback effect from among these programs is executed, the controller 120 may control the display 110 to display a UI screen corresponding to the program. The controller 120 controls the feedback provider 130 to provide the local feedback effect to the UI screen according to the above-described exemplary embodiment. The example of the UI screen and the examples of the feedback in the UI screen have been described above. Thus, a redundant explanation is omitted.

Although various program modules are illustrated in FIG. 19, some of the program modules may be omitted, modified, or added according to a type and characteristic of the user terminal apparatus 100.

In the above-described exemplary embodiment, the piezoelectric feedback effect is locally provided. However, various feedback effects other than the piezoelectric feedback effect may be locally provided. For example, the feedback provider 130 may include a plurality of heaters which are arranged in the user terminal apparatus 100. Accordingly, by selectively driving only a heater that is disposed in a specific area, heat may be sensed from that area. In other words, a feedback effect using temperature may be provided.

A feedback effect using a sound or light may be provided. In an exemplary embodiment in which a feedback effect is provided using a sound, a specific sound may be provided only when the user places his/her fingers only on a specific area, e.g., a guide key. On the other hand, in an exemplary embodiment in which a feedback effect is provided using light, only brightness of a specific area, e.g., a guide key may be adjusted to be brighter than the other areas, or elements such as light emitting diodes provided in the user terminal apparatus may flick only when the user places his/her fingers on the corresponding key. These feedback effects may be provided individually or in combination with the above-described piezoelectric feedback effect.

The method for providing the feedback of the user terminal apparatus according to the above-described exemplary embodiments may be coded as software and may be mounted in various apparatuses.

In particular, a non-transitory computer readable medium, which stores a program, may perform: displaying a UI screen on a display having flexibility, and, when it is determined a user has an intention to input on the UI screen, locally providing a feedback effect to at least one area from among all areas of the display, may be installed.

The non-transitory computer readable medium refers to a medium that stores data semi-permanently, rather than storing data for a very short time, such as a register, a cache, and a memory, and is readable by an apparatus. In particular, the above-described various applications or programs may be stored in a non-transitory computer readable medium, such as a compact disc (CD), a digital versatile disk (DVD), a hard disk, a Blu-ray disk, a universal serial bus (USB), a memory card, and a read only memory (ROM), and may be provided.

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A user terminal apparatus comprising:
a display configured to have flexibility and display a user interface (UI) screen;
a feedback provider which locally provides a feedback effect in at least one area of the display; and
a controller configured to control the feedback provider to locally provide the feedback effect to the at least one area of the display, among all areas of the display, in response to determining that a user intends to provide an input on the UI screen.

2. The user terminal apparatus as claimed in claim 1, wherein the controller controls the feedback provider to provide the feedback effect to the at least one area of the display which corresponds to a point at which a specific key is displayed on the UI screen.

3. The user terminal apparatus as claimed in claim 1, wherein the UI screen comprises a soft keyboard comprising a plurality of keys,
wherein the controller controls the feedback provider to provide the feedback effect to the at least one area of the display which corresponds to a point at which at least one guide key which specifies a finger arrangement location, among the plurality of keys, is displayed.

4. The user terminal apparatus as claimed in claim 1, further comprising an approach sensor configured to sense a user approach,
wherein the controller determines that the user intends to provide the input on the UI screen in response to sensing the user approaching the UI screen when the UI screen is displayed.

5. The user terminal apparatus as claimed in claim 1, further comprising a touch sensor configured to sense a user touch on the UI screen,
wherein the controller controls the feedback provider to provide a first feedback effect to the at least one area of the display that corresponds to a point at which a specific key is displayed on the UI screen in response to the user touching the UI screen with a pressure less than a predetermined level of pressure.

6. The user terminal apparatus as claimed in claim 5, wherein the UI screen comprises a soft keyboard comprising a plurality of keys,
wherein the specific key is at least one guide key which specifies a finger arrangement location, among the plurality of keys,
wherein the controller controls the feedback provider to provide a second feedback effect to the at least one area of the display that corresponds to the point in response to the user touching the UI screen with a pressure greater than the predetermined level of pressure.

7. The user terminal apparatus as claimed in claim 1, wherein the feedback provider comprises a plurality of piezoelectric elements in the user terminal apparatus, and which provide a haptic feedback effect by locally deforming a surface of the display.

8. The user terminal apparatus as claimed in claim 7, wherein the feedback effect is at least one of a vibration, a protrusion, and a depression.

9. A method for providing feedback of a user terminal apparatus, the method comprising:
displaying a user interface (UI) screen on a display which has flexibility; and
locally providing a feedback effect to at least one area of the display, among all areas of the display, in response to determining that a user intends to provide an input on the UI screen.

10. The method as claimed in claim 9, wherein the feedback effect is provided to the at least one area of the display which corresponds to a point at which a specific key is displayed on the UI screen.

11. The method as claimed in claim 9, wherein the UI screen comprises a soft keyboard comprising a plurality of keys,
wherein the feedback effect is provided to the at least one area of the display which corresponds to a point at which at least one guide key which specifies a finger arrangement location, among the plurality of keys, is displayed.

12. The method as claimed in claim 9, wherein the locally providing the feedback effect comprises determining that the user intends to provide the input on the UI screen in response to sensing the user approaching the UI screen when the UI screen is displayed.

13. The method as claimed in claim 9, wherein the locally providing the feedback effect comprises providing a first feedback effect to the at least one area of the display that corresponds to a point at which a specific key is displayed on the UI screen in response to the user touching the UI screen with a pressure less than a predetermined level of pressure.

14. The method as claimed in claim 13, wherein the UI screen comprises a soft keyboard comprising a plurality of keys,
wherein the specific key is at least one guide key which specifies a finger arrangement location, among the plurality of keys,
wherein the locally providing the feedback effect comprises providing a second feedback effect to the at least one area of the display that corresponds to the point in response to the user touching the UI screen with a pressure greater than the predetermined level of pressure.

15. The method as claimed in claim 9, wherein the locally providing the feedback effect comprises automatically determining that the user intends to input on the UI screen in response to the UI screen being a UI screen through which the user inputs and the UI screen being displayed.

16. The method as claimed in claim 9, wherein the locally providing the feedback effect comprises providing a haptic feedback effect which locally deforms a surface of the display by selectively driving at least one piezoelectric element which is arranged in the at least one area, among a plurality of piezoelectric elements in the user terminal apparatus.

17. A method for providing feedback of a user terminal, the method comprising:
displaying a user interface (UI) screen on a display;
sensing a user touch and determining a touch pressure intensity of the user touch; and
providing one of a first feedback effect and a second feedback effect to a local region of a predetermined location based on the touch pressure intensity of the user touch.

18. The method of claim 17, wherein the first feedback effect is provided when the touch pressure intensity is less than a predetermined level of pressure.

19. The method of claim 17, wherein the second feedback effect is provided when the touch pressure intensity is greater than a predetermined level of pressure.

20. The method of claim 17, wherein the first feedback effect is at least one of a protrusion or a depression, and the second feedback effect is a vibration.
